(19) United States
(12) Patent Application Publication
(10) Pub. No.: US 2018/0219992 A1
(43) Pub. Date: Aug. 2, 2018

(54) HAND HELD BIOMETRIC MOUNT FOR MOBILE PHONES

(71) Applicant: InCadence Strategic Solutions Corporaton, Manassas, VA (US)

(72) Inventors: Anthony S. Iasso, Middleburg, VA (US); Ian Nathan, Charlottesville, VA (US); John McIntyre, Stephens City, VA (US)

(73) Assignee: InCadence Strategic Solutions Corporaton, Manassas, VA (US)

(21) Appl. No.: 15/748,403

(22) PCT Filed: Jul. 29, 2016
(86) PCT No.: PCT/IB2016/054591

§ 371 Date: Jan. 29, 2018

Related U.S. Application Data
(60) Provisional application No. 62/198,640, filed on Jul. 29, 2015.

(51) Int. Cl. H04M 1/725; G06K 9/00

(52) U.S. Cl. CPC H04M 1/72527; G06K 9/00006

(57) ABSTRACT

A hand held biometric mount for mobile phones, tablets, or similar devices of different sizes can provide for mobile biometric sensing in an integrated device that allows for the easy and rapid connection, docking, and disconnection of phones or tablets of various sizes to biometric sensors that can be housed in the mount. The device can include a mount base configured to support and hold a mobile phone and a biometric sensor. The mount can further include an adjustable bracket configured to securely hold and release the mobile phone. The adjustable bracket can include a ratchet or similar mechanism to adjust to the size of the phone or other device and hold it in place. The phone and biometric sensor can be connected via wired or plug-type connections that are integrated within the base or by a wireless connection.

### CROSS-REFERENCE TO RELATED APPLICATIONS

This application claims priority from U.S. Provisional Patent Application Ser. No. 62/198,640, filed Jul. 29, 2015, the disclosure of which is hereby incorporated by reference in its entirety.

### STATEMENT REGARDING FEDERALLY SPONSORED RESEARCH OR DEVELOPMENT

Not Applicable.

### BACKGROUND

### Field

The disclosed subject matter is generally directed to docks and mounts for mobile devices, and more particularly, to devices and methods that provide for integrating biometric sensors into adjustable mounts for mobile phones and tablets of different sizes.

### Description of Related Art

Mobile phone mounts are known. One example is disclosed in U.S. Pat. No. 8,712,482 to Sorias et al. for a detachably integrated battery charger for mobile cell phones and like devices.

Biometric sensors, such as fingerprint sensors, are also known. In one particular application, fingerprint sensors that are suitable for law enforcement and national security purposes typically have, at a minimum, the ability to collect two fingerprints simultaneously, and have the ability to collect rolled fingerprints using the sensor. The minimum certified size of a device for this purpose is currently 1.6 inches×1.5 inches, and is in an FBI “Certification Category” known as “Fingerprint Acquisition Profile 45”, or FAP 45. FIG. 1 shows a listing of FAP certification categories and platen sizes for fingerprint sensors. Known fingerprint sensors of the FAP 45 category size factor have been developed for connection to mobile phones and tablets. These sensors can be powered from the phone or tablet without an external power source. They can be connected to the fingerprint device through a wire, using a standard connector such as a Universal Serial Bus (USB) plug, or through wireless protocols, such as the Bluetooth protocol.

The pairing of a FAP 45 fingerprint sensor with a commercial smart phone can allow users to collect and submit fingerprints to a variety of networked systems that are capable of performing fingerprint matching and returning match results. The greater mobility of the mobile phones and tablets, along with the smaller FAP 45 fingerprint sensors, enables use of this technology for performing identification checks anywhere that users encounter a person of interest, rather than having to bring the person to a fixed location, such as a booking station at a police station.

There is a need, however, to be able to pair commercial smart phones of various sizes and shapes to fingerprint sensors in such a way that the phone and fingerprint sensor can be easily and quickly connected and paired together, and mounted in such a way that the user can hold both easily in one hand. Similarly, there is also a need such that the phone can be easily unpaired and removed for regular use, without being paired to the fingerprint sensor. Many law enforcement and national security organizations purchase their own phones, of various makes and models. In order to collect fingerprints from a FAP 45 fingerprint device using a smart phone as the computing platform, the user has to handle and control both the smart phone and the fingerprint device at the same time. This is difficult when the devices are simply wired together using a wire and plug, or connected wirelessly using a wireless protocol. There is a need for an adjustable mount that can hold both phones of various sizes and a fingerprint sensor at the same time. An adjustable mount would also allow the phone to be easily inserted or removed, and the fingerprint device to be easily inserted or removed should it become damaged and require replacement.

### SUMMARY

The disclosed subject matter relates to a hand held biometric mount for mobile phones that provides for mobile biometric sensing in an integrated device that allows for the easy and rapid connection and disconnection of phones, tablets, etc., of various sizes to biometric sensors. In an embodiment, a hand held biometric mount for mobile phones can include a mount base configured to support a mobile phone and a biometric sensor. The mount can further include an adjustable bracket configured to securely hold and release the mobile phone. The adjustable bracket can include a ratchet or similar mechanism to adjust to the size of the phone and hold the phone in place. The phone and biometric sensor can be connected via wired or plug-type connections that are integrated within the base or by a wireless connection.

In an embodiment, a hand held mount can include a mount base, also known as a phone support deck, configured to support a communications device. The mount can further include an adjustable bracket configured to securely hold and release the communications device and a sensor housing or sensor well configured to support a sensor. In an embodiment, the biometric sensor can be a fingerprint sensor.

### BRIEF DESCRIPTION OF THE DRAWINGS

As will be realized, different embodiments are possible, and the details disclosed herein are capable of modification in various respects, all without departing from the scope of the claims. Accordingly, the drawings and descriptions are to be regarded as illustrative in nature and not as restrictive. Like reference numerals or characters are used throughout the several views and embodiments to designate like components.

FIG. 1 shows a table with certification categories based on FBI biometric specifications for fingerprint devices;

FIGS. 2A and 2B show front views of an embodiment of a hand held biometric mount for mobile phones;

FIGS. 3A and 3B show rear views of an embodiment of a hand held biometric mount for mobile phones;

FIGS. 4A, 4B and 4C show side views of an embodiment of a hand held biometric mount for mobile phones;

FIG. 5 shows a phone support deck and sensor well in an embodiment of a hand held biometric sensor mount for mobile phones.

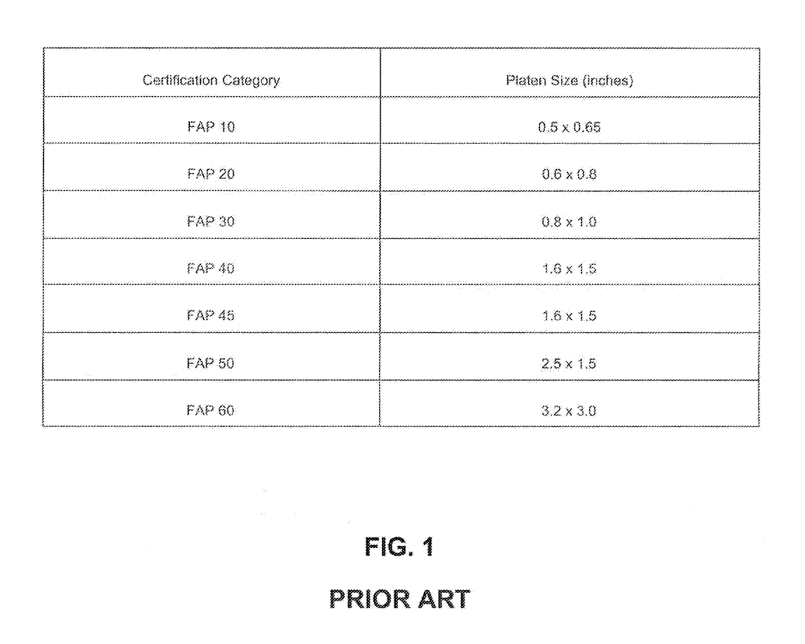

### DETAILED DESCRIPTION

To facilitate an understanding of the principles upon which the subject matter disclosed herein is based, various illustrative embodiments are described hereinafter with reference to their implementation as a hand held mount for mobile phones that includes a fingerprint sensor. It will be appreciated that the practical applications of these principles are not limited to this particular type of implementation. Rather, they can be equally employed in any other type of mobile device, such as tablet computing devices of various sizes, and different biometric sensors, such as iris readers, where it is desired to provide for mobile biometric sensing in an integrated device that allows for the easy and rapid connection and disconnection of phones, tablets, etc., of various sizes to biometric sensors.

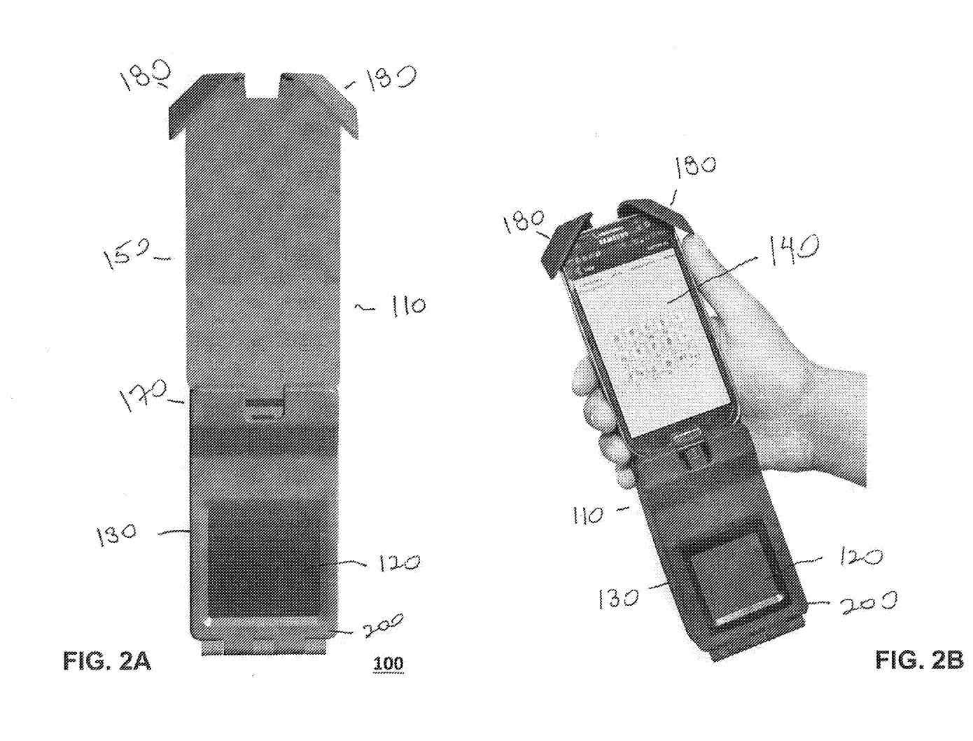

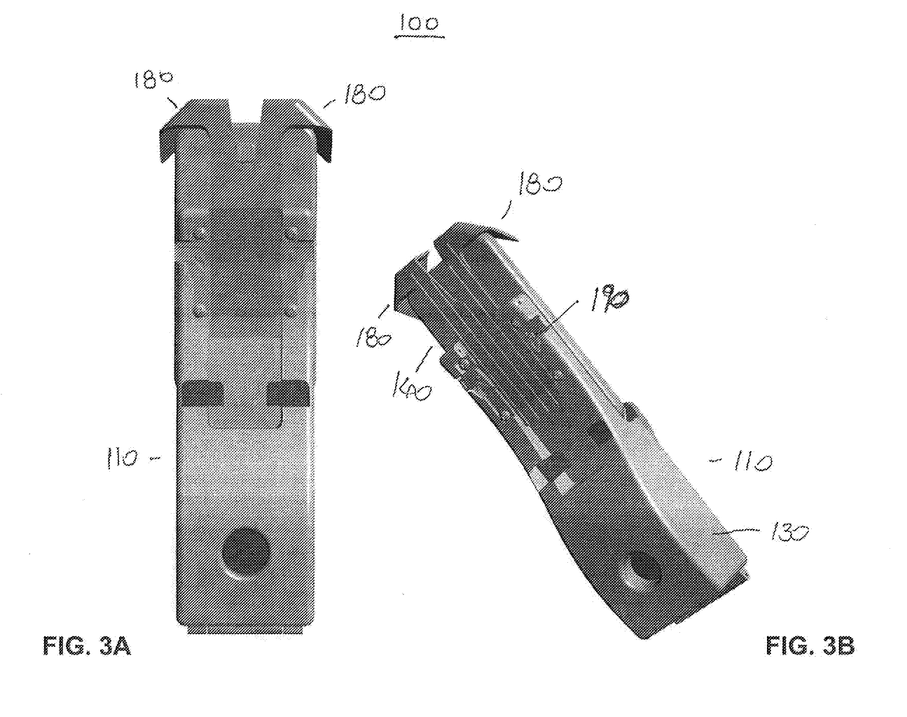

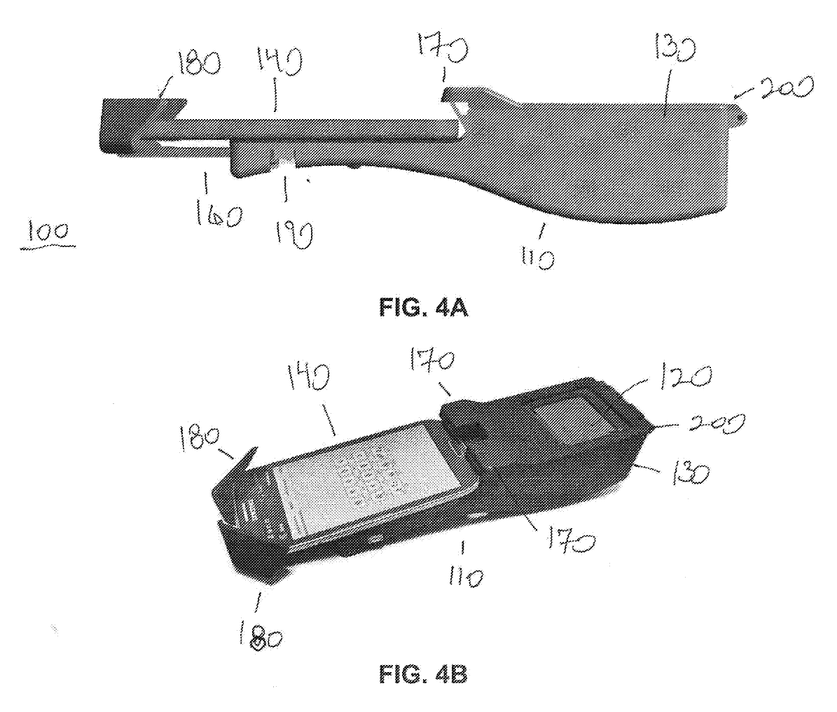

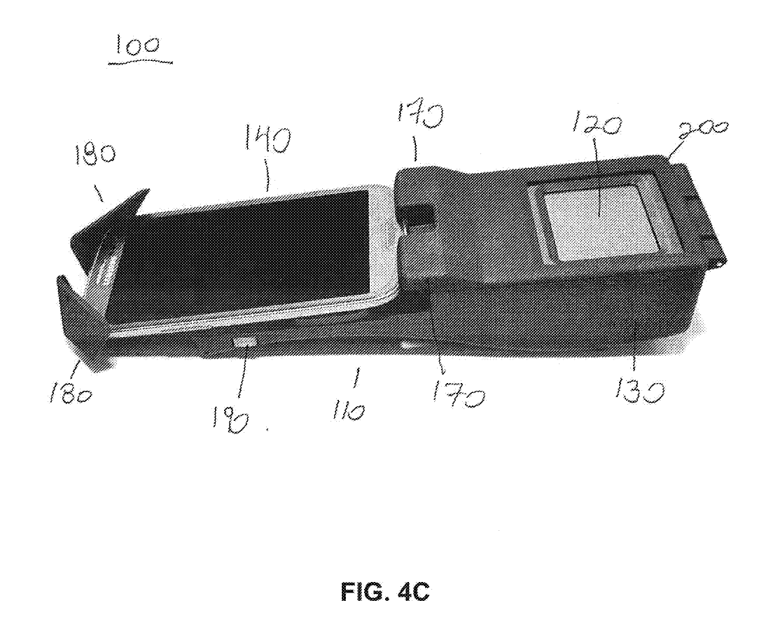

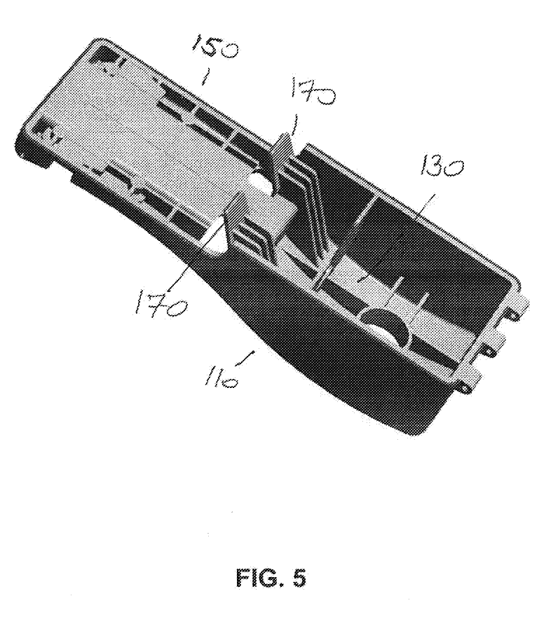

FIGS. 2-5 show exemplary embodiments of a hand held biometric mount for mobile phones 100. In an embodiment, a biometric hand held mount 100 can include a mechanical mount base 110 that can hold a biometric sensor 120, such as a two-fingerprint sensor in a sensor housing or well 130, and a mobile communications and/or computing device 140, e.g., a mobile phone, such as a smart phone. In an embodiment, each of the components can easily be inserted and removed from the mount when needed.

In an exemplary embodiment, to capture and hold a wide variety of phones, the mount can include a self-centering holder 150. The holder can be responsible not only for securely holding a variety of phones, but protecting them as well.

In an embodiment, an adjustable bracket 160, such as a sliding bracket, can hold phones of different widths as well as lengths, and different size ratios. In an embodiment, the bottom of a phone can rest on two angled brackets 170, while the top corners 180 on the sliding bracket can be angled and can accommodate and hold phones as wide as the top part of the sliding bracket.

In an exemplary embodiment, a suitable mechanism, such as a ratchet mechanism 190, can secure the sliding bracket or plate at a desired length. The ratchet mechanism can be configured to easily hold and release the phone by pressing two buttons on either side of the mount, to name a nonlimiting example.

In an exemplary embodiment, a fingerprint sensor can be connected to the phone's micro USB port, for example, prior to inserting into the mount. Nonlimiting examples of fingerprint sensors that can be used include models by Integrated Biometrics, such as the Watson Mini, the Sherlock, and the Columbo. A half-inch or other suitably sized channel between the phone and sensor, for example, can hold and protect a two-inch fingerprint sensor cord, for example. A hinged cover plate 200, for example, can be used to close over the fingerprint sensor to securely hold both the sensor and phone in place.

In various exemplary embodiments, suitable mechanisms to adjust and hold the phone in conjunction with the sliding bracket can include spring-loaded or spring-force clamps or clips, screw-based clamps or clips, and ratchet-based clamps or clips, to name a few nonlimiting examples.

In various embodiments, suitable materials used to make the mount can include plastics or polymers, metals, rubber, carbon fiber, and fiberglass, to name a few nonlimiting examples.

In various embodiments, suitable ways for connecting the phone to the sensor can include wired connections via Universal Serial Bus (USB), Firewire, or other types of wired connections, wireless connections via Bluetooth, an 802.11 network, or other types of wireless connections, and direct connection using a rigid plug or connector, to name a few nonlimiting examples.

The above description is presented to enable a person skilled in the art to make and use the devices and methods described herein, and is provided in the context of a particular application and its requirements. Various modifications to the embodiments will be readily apparent to those skilled in the art, and generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. A hand held mount, comprising:
a mount base configured to support a communications device, wherein the mount further comprises an adjustable bracket configured to securely hold and release the communications device;
and
a sensor housing configured to support a sensor.

2. The hand held mount of claim 1, wherein the communications device is a mobile phone.

3. The hand held mount of claim 1, wherein the communications device is a tablet computing device.

4. The hand held mount of claim 1, wherein the sensor comprises a biometric sensor.

5. The hand held mount of claim 4, wherein the biometric sensor is a fingerprint sensor.

6. The hand held mount of claim 1, wherein the adjustable bracket comprises a ratchet mechanism to adjust to the size of the mobile communications device and hold the mobile communications device in place.

7. The hand held mount of claim 1, wherein the communications device and sensor are connected by at least one of a wired and plug-type connection that is integrated within the base.

8. The hand held mount of claim 1, wherein the communications device and sensor are operatively connected by a wireless connection.

9. The hand held mount of claim 1 further comprising a cover to hold the sensor in place.

10. The hand held mount of claim 9, wherein the cover is a hinged cover plate.
